(19) United States
(12) Patent Application Publication
(10) Pub. No.: US 2008/0039966 A1
(43) Pub. Date: Feb. 14, 2008

(54) SYSTEM AND METHOD FOR REDIFFUSION OF AUDIO DATA

(75) Inventors: Mark Anthony Redgewell, Balmain (AU); David Christopher Hutchinson, Wamberal (AU)

Correspondence Address: CONLEY ROSE, P.C.;David A. Rose, P. O. BOX 3267, HOUSTON, TX, 77253-3267, US

(73) Assignee: NEWSNET LTD, Sydney (AU)

(21) Appl. No.: 11/836,225

(22) Filed: Aug. 9, 2007

(30) Foreign Application Priority Data
Aug. 9, 2006 (AU) 2006904298

(51) Int. Cl. G06F 17/00

(52) U.S. Cl. 700/94

(57) ABSTRACT

A system and method for rediffusion of audio data. The rediffusion of audio data occurs in real-time and includes capturing live audio using a wireless communications device, such as a mobile or cell phone. The captured audio is then transmitted to a media server where it is received and processed into audio data, such as a text transcript or compressed into a storable format. An end user may be notified of the processed audio data, and can request access to it. The audio data is then distributed to the end user via the end user's desired medium.

### CROSS-REFERENCE TO RELATED APPLICATIONS

This application claims the benefit of Australian Application No. 2006904298 titled “System And Method For Rediffusion Of Audio Data”, filed Aug. 9, 2006, and incorporated by reference herein as if reproduced in full below.

### BACKGROUND

1. Field

The various embodiments relate to rediffusion of audio data. More particularly, the various embodiments concern a system and method for the electronic capture and distribution of audio data in real-time.

2. Description of the Related Art

Traditionally, digital tape recorders are used to capture speech at live audio events, such as media releases, conferences, and announcements.

In order for the information to be conveyed to the public, the captured audio is involved in a long workflow process. Firstly, the recordings must be physically taken back to a workstation, uploaded onto a messaging server and transcribed, as required, by a stenograph (physically operated by a stenographer), or processed by speech-to-text software. The transcribed material is then formatted and edited by an editorial team or journalist in order to move to publication.

At some later time, parties interested in the content of the speech or press announcement are able to access the transcript or request the audio file via a download or a data medium, such as a CD.

This process is time consuming and laborious, and may take between 4 to 8+ hours before the information content is readily available to a wider audience.

Present real-time applications, such as internet broadcasts, provide no flexibility for content editing and processing, and are still limited to the time required for the audio to be uploaded and broadcast on relevant mediums.

The various embodiments described in this specification advantageously provide an alternative to access audio data. The system and method according to certain embodiments may advantageously be used to provide real-time accessibility to information.

### SUMMARY

According to a first aspect, there is provided a method of rediffusion of audio data in real-time; including capturing and transmitting live audio to a media server using a wireless communications device. Once the live audio is received, it is processed into audio data. This audio data is then published on a desired medium.

According to another aspect, the wireless communications device is a mobile or cell phone. Alternatively, the wireless communications device may be a PDA or other similar communications device capable of sending audio/voice messages.

The audio data is, in some embodiments, a transcript of the live audio (processed by a stenographer or using speech-to-text software applications), or may be an audible file of the live transmission (processed by known sampling and compression techniques) converted to a format such as MP3 or WAV.

In accordance with a further aspect, there is provided a method of distributing audio data to an end user in real-time, including: capturing and transmitting live audio to a media server using a wireless communications device; receiving and processing the received captured live audio into audio data on the media server; notifying the end user of the processed audio data; receiving a request for access to the processed audio data from the end user; and distributing the audio data to the end user via the end user's desired medium.

According to yet another aspect, the end user is notified of the processed audio data by a SMS (Short Message Service), email, or similar messaging service, such as a recorded voice message sent to the end user's fixed or mobile communications device.

According to another aspect, the end user's desired medium to receive the audio data may include accessing a transcribed file or audio file from a web page, fax delivery or using an IVR system to access audio files directly on a fixed or mobile communications device.

According to yet another aspect, the request for access to the processed audio data from the end user is processed by a subscription access module to determine if the end user has the required permissions to access the requested audio data.

In accordance with another aspect, there is provided a method of distributing audio data to an end user in real-time, including: registering the end user on a media server, including a user's key content preferences; capturing and transmitting live audio to the media server using a wireless communications device; receiving and processing the received captured live audio into audio data on the media server; analyzing the audio data for the user's key content preferences; notifying the end user of the audio data, according to the user's key content preferences; receiving a request for access to the audio data from the end user; and distributing the audio data to the end user via the end user's desired medium.

According to yet another aspect, the audio data is a transcription of the captured audio, and the analyzing of the audio data for the user's key content preferences includes a keyword search of the transcription.

According to another aspect, registering the end user on a media server includes receiving billing information from the end user.

In accordance with yet another aspect, there is provided a method of distributing audio data to an end user in real-time, including: registering the end user on a media server, including a user's key content preferences; notifying the end user of an audio broadcast, according to the user's key content preferences, prior to the commencement of the audio broadcast; receiving a request for access to audio data relating to the audio broadcast from the end user; capturing the audio broadcast once it commences using a wireless communications device; and distributing the audio data to the end user.

According to another aspect, the audio data may be a direct streaming of the audio or a transcription of the audio broadcast.

In accordance with a further aspect, there is provided a system for distributing audio data to an end user in real-time, including: a wireless communications device for capturing and transmitting live audio; and a media server configured to receive and process the live audio transmission into audio data; including an administrative module configured to notify the end user of the audio data; an access module for receiving and processing a request for access to the audio data from the end user; and a distribution module for distributing the audio data to the end user.

According to another aspect, the administrative module includes a database comprising registration details of end users, including contact information, desired medium to receive requested audio data, and billing information.

In accordance with yet another aspect, there is provided a system for distributing an audio broadcast to an end user in real-time, including: a media server, including: an administrative module configured to notify the end user of the availability of audio data prior to an audio broadcast; an access module for receiving and processing a request for access to the audio data from the end user; and a wireless communications device for capturing the audio broadcast once it commences and transmitting the broadcast to the end user.

### BRIEF DESCRIPTION OF THE DRAWINGS

For a detailed description of exemplary embodiments, reference will now be made to the accompanying drawings in which:

FIG. 1 is an overview of at least some embodiments;

FIG. 2 is a conceptual diagram of the modules employed in the system according to at least some embodiments;

FIG. 3 is an overview of at least some embodiments;

FIG. 4 is a further overview of at least some embodiments;

FIG. 5 is an overview of at least some embodiments; and

FIGS. 6a-6c are administrative examples of at least some embodiments.

### NOTATION AND NOMENCLATURE

Certain terms are used throughout the following description and claims to refer to particular system components. As one skilled in the art will appreciate, news and audio content delivery companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection or through an indirect connection via other systems and devices.

Additionally, in the following discussion and in the claims that follow, the term “rediffusion” is to be given a broad meaning and refers to distributing media content, in particular audio content.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

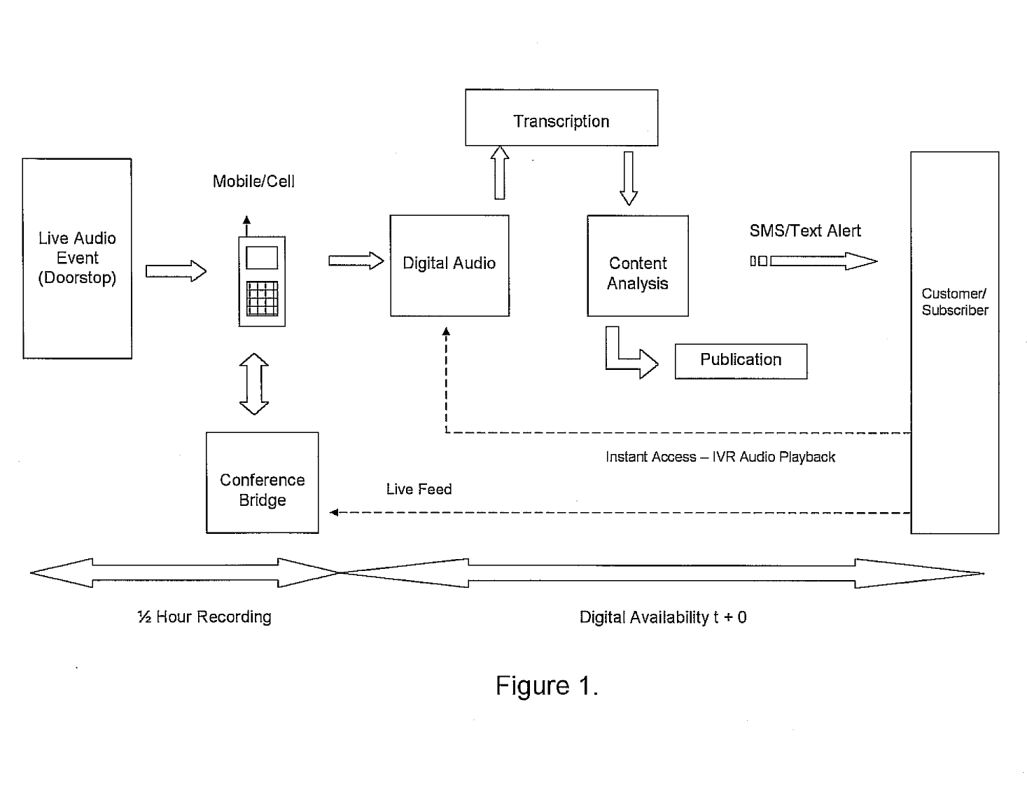

Referring now to FIG. 1, an overview of the system according to at least some embodiments is shown. The term “Doorstop” is used to refer to a live audio event, such as media releases, conferences, and announcements.

The live audio is captured and transmitted to a media server using a wireless communications device. In this instance the device is a mobile or cell phone, however the wireless communications device may also be a PDA, or other personal communications device capable of transceiving audio.

Once received at the media server, the audio is processed for distribution to an end user. The processing may include storage on a database for access by a stenographer to transcribe the audio. Additionally, the processing may include formatting the audio using DSP (Digital Signal Processing) and desired compression techniques (such as MP3, or WAV, for example), for storage on a database.

Further processing of the audio may include indexing and archiving for later retrieval.

Where an audio transmission is transcribed, the resulting text may be further processed for content analysis using a keyword search. If any keywords correspond to a listing of keywords previously provided by an end user, the end user may be alerted to the processed audio. Such an alert may be a SMS sent to the end user's mobile phone, an email sent the end user's designated email address, or a voice message.

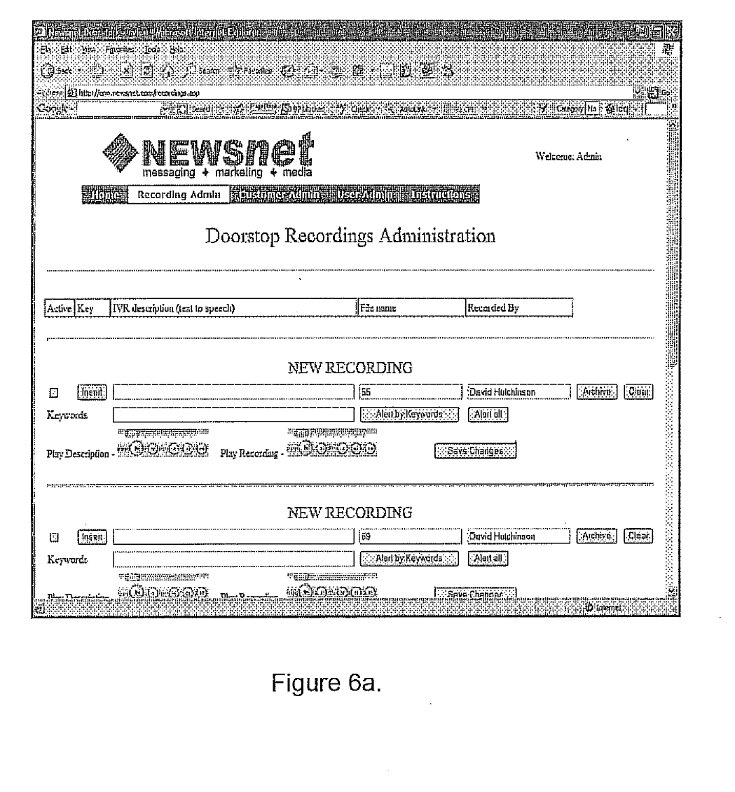

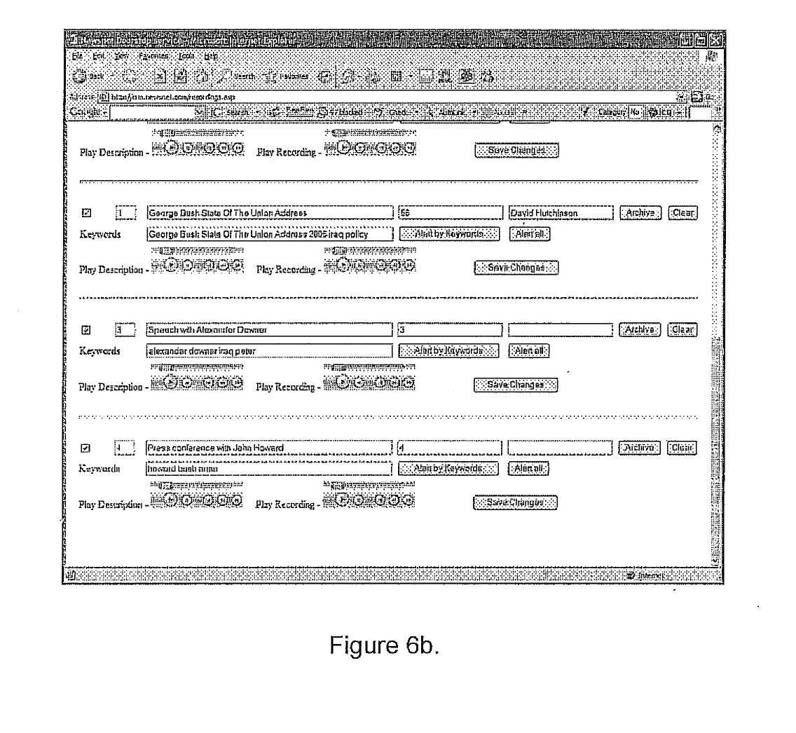

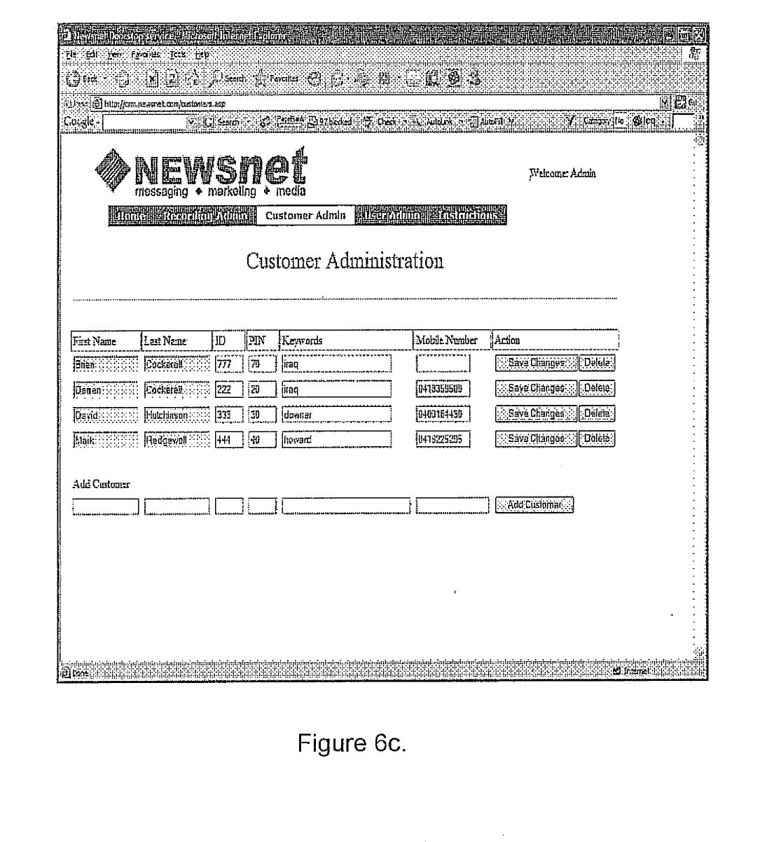

The transcribed audio can be published or stored for later retrieval by end users.

Where an audio transmission is stored as a digital audio file, an end user may be alerted to the processed audio in a similar manner to that described above. The alert may simply advise the end user that a processed audio file is available for delivery via the user's chosen medium. Further discussion on retrieval and distribution of stored processed audio, whether a transcribed file or a compressed audio file, is below with reference to FIGS. 6a-6c.

The end user may also have access to the live audio via a conference bridge. The end user may be notified of the Doorstop event in a manner discussed above prior to the event, and access the conference bridge once the event begins. Alternatively, the user may be notified of a broadcast prior to the commencement of the broadcast, and access the processed audio of the broadcast at a later time (after the event has finished, for example).

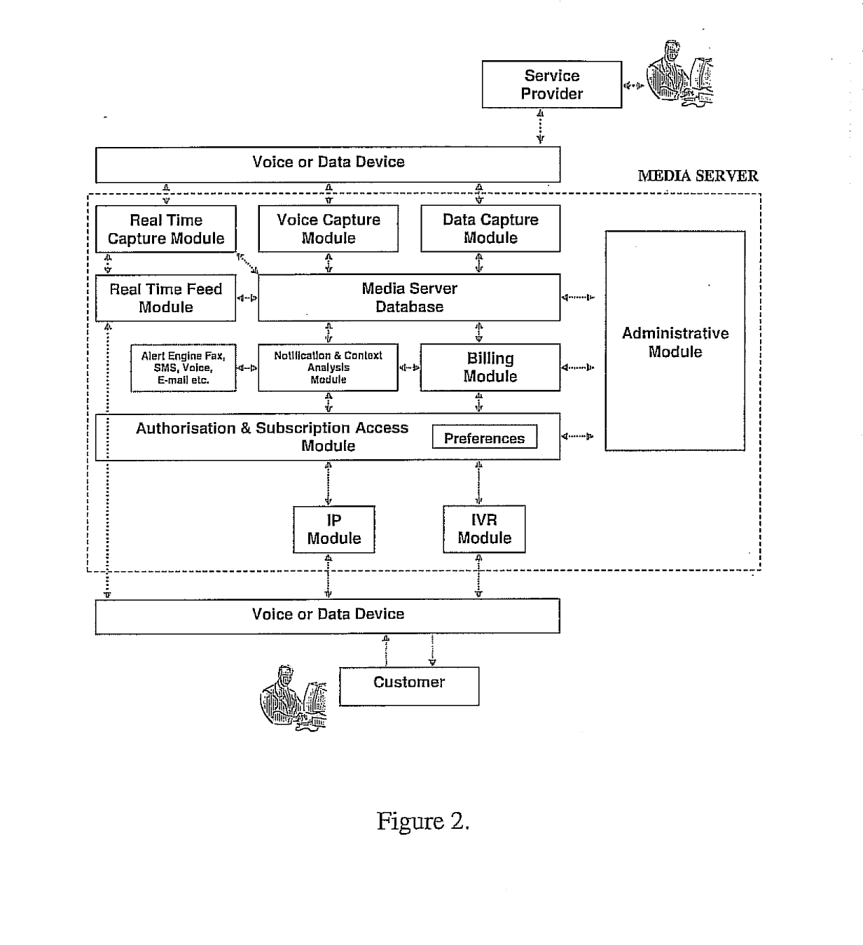

FIG. 2 is a conceptual overview of the modules employed in accordance with at least some embodiments. The pertinent modules of the media server relating to the various embodiments are explained below. The functionality of those modules not discussed in detail below would be readily understood by the skilled addressee.
A Voice Capture Module used to record sound files such as speeches, conferences or other audio received through a phone call or similar communication for storage onto a media server database.
A Data Capture Module allowing the upload of electronically recorded audio files and subsequent storage onto a media server database.
A Real Time Capture Module allowing media feeds to be captured in real time and using the Real Time Feed Module streamed or transmitted via web audio/media streaming devices, telephony devices or IP enabled applications in handheld devices created to process real time feeds.
Media Server Database module for the storage, indexing, retrieval and archiving of audio material. May also provide optional storage of transcribed text files where audio material is converted to textual data for later retrieval and usage by other modules described herein.
Administrative Module allowing system operators to index, transcribe, add, remove, delete, manipulate the content and availability of both text and audio material contained on the Media Server Database. Also the configuration of IVR and Web menu structures for an end user's access to current processed audio or access to archived materials.
Authorization and Subscription Access Module to determine end user and administrator access to areas of the system by way of password, username, account number, PIN number or combination thereof. Also the capture of information relating to the interest of the end user with regard to the type of material that is of interest, such as political speeches or those given by specific individuals or relating to specific companies or organizations. Consideration also provided for the end user to specify unstructured keywords for the Notification Module to later determine items of interest for the user.
Billing Module for the calculation, tracking and billing of charges to end users or service providers for the access to and usage of the services by way of either data utilized, bandwidth, access time or similar or combinations thereof against predetermined tariffs & charges for the said customer and/or service provider. The Billing Module may also utilize the Notification Module for alert of notification of account related issues such as bills not paid on time, low credit, number of minutes used or cost of previous transactions.
IVR Access Module for the access by an end user to audio material via direct audio playback of the material or playback over the audio device using text-to-speech for example, by way of conversion of the transcribed materials to speech files and subsequent playback. IVR Access can also provide the ability for rewinding and fast forwarding the current position in audio playback, change menu position, change of access details such as PIN number etc.
IP Access Module for the access or download by an end user to the material via direct data connection via web browser or other IP enabled device to retrieve one or more variations of the service such as audio files, transcribed files, and text-to-speech files.
Notification Module and Context Analysis Module for the notification to end users that a new file is available for retrieval. The module notifies the user via preferred or available services such as e-mail, SMS, voice message, and facsimile for example, of the availability of material that will be of interest to the user as either determined by the user's selected preferences or those determined by the Notification Module to be of interest to the customer by association and calculation of the content within an available module. Context and Content Analysis can also be performed whenever transcriptions of audio files are available and loaded on the system. The transcript can be scanned for keywords registered or provided by the user relating to their particular interests. A notification engine can then provide alerts to the user that relevant keywords have been located (or located close to other keywords) and advise how to retrieve the audio or transcribed files.

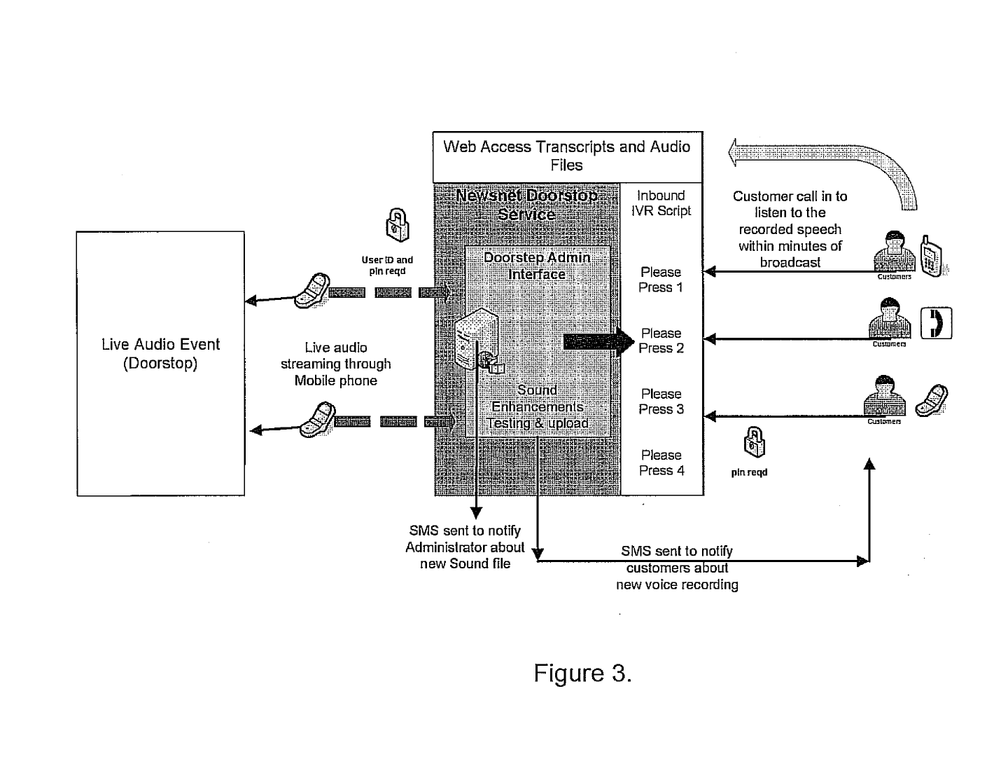

FIG. 3 shows at least some embodiments, and in particular detailing how an end user may access processed audio.

Particular attention is drawn to the notification sent to the end user. In this example, the notification is a SMS message. As will be appreciated, the notification may also be an email, facsimile, voice message or the like.

The end user may then access the processed audio via a desired medium. As shown in the example of FIG. 3, the end user may access the processed audio via a mobile or fixed line telephone, or via a PDA. Another medium (not shown) that may be employed by an end user may be a personal computer via the internet.

Security measures may be incorporated into the system, and require a user to log in to the service. This allows the system to monitor usage for billing or marketing purposes, for example.

For internal management, the system may notify an administrator of the processed audio by similar means to that described above. In the example shown in FIG. 3, the notification is a SMS.

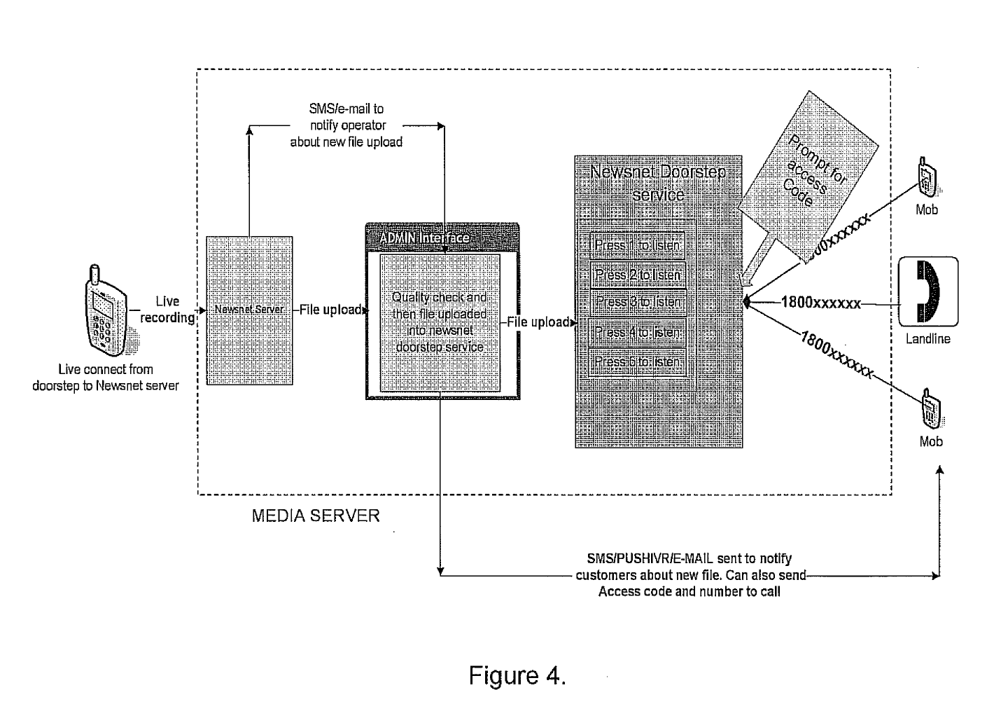

FIG. 4 depicts a similar embodiment to that shown in FIG. 3. Specifically, the figure shows the flow of captured audio for uploading to a server database for access by an end user. The transcription or compression processing steps of the audio (not shown) are completed, and the processed audio is tested for sound quality, and any corruption of the processed audio. The audio may then be uploaded for availability to the end user.

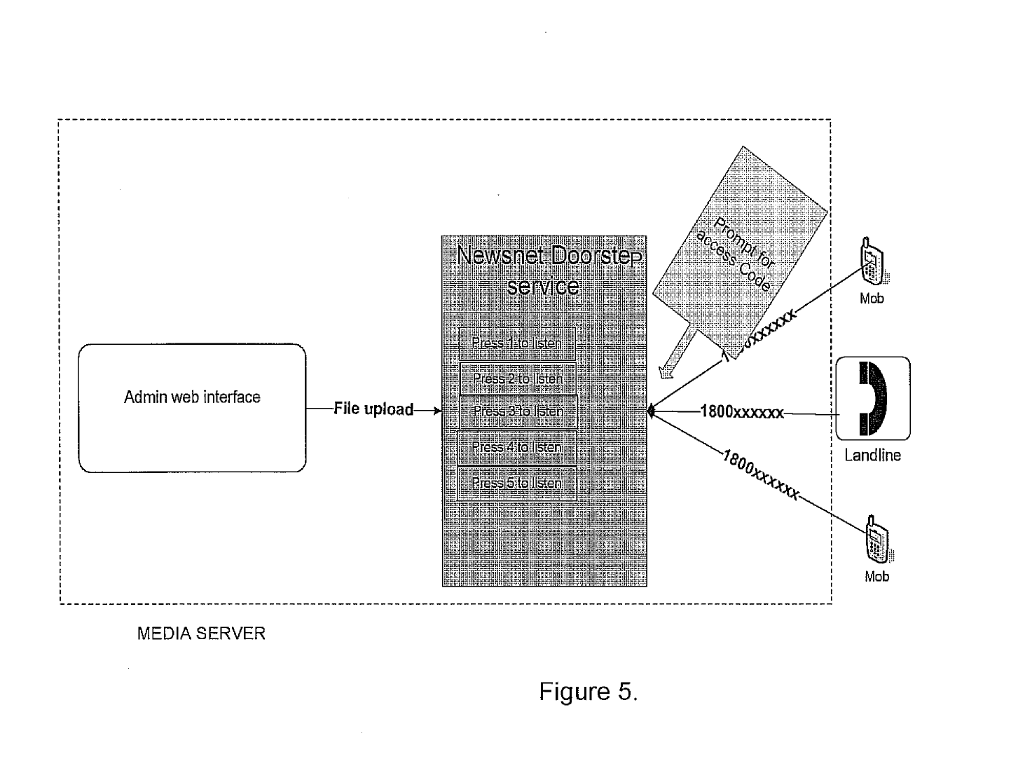

FIG. 5 shows further embodiments, where a processed audio file may be uploaded for access by an end user via a web interface. Examples of the interface are shown in FIGS. 6a-6c. Such a web based administrative interface would include the following functionality:
Capability for an end user to upload voice files and add IVR scripts relating to the voice files.
Reduce or increase the number of messages stored for a particular number (for example, incoming calls to this number will hit an IVR script and various options are given to listen to different messages).
Can alter the IVR messages. (for example, “Please press one to listen to the Prime Minister's speech”, would be editable).
Can send messages via SMS, e-mail or PUSHIVR to a broadcast list or individuals. Once a processed audio file has been uploaded, the end user is notified to call a number and listen to the message(s).
Manage address book, including merge fields such as access codes and contact numbers, for example.
Once the processed audio is ready for uploading, it can be distributed onto a web site or can be uploaded directly on the server for fast transmission.

It will of course be realized that whilst the above has been given by way of an illustrative example, all such and other modifications and variations hereto, as would be apparent to persons skilled in the art, are deemed to fall within the broad scope and ambit of this invention as is herein set forth.

1. A method of rediffusion of audio data in real-time, including:
capturing and transmitting live audio to a media server using a wireless communications device;
receiving and processing the received captured live audio into audio data; and
publishing the audio data.

2. The method of rediffusion of audio data as defined in claim 1, wherein the wireless communications device is a mobile or cell phone.

3. The method of rediffusion of audio data as defined in claim 1, wherein the audio data is a transcript of the live audio.

4. The method of rediffusion of audio data as defined in claim 1, wherein the audio data is an audible file of the live transmission.

5. A method of distributing audio data to an end user in real-time, including:
capturing and transmitting live audio to a media server using a wireless communications device;
receiving and processing the received captured live audio into audio data on the media server;
notifying the end user of the processed audio data;
receiving a request for access to the processed audio data from the end user; and
distributing the audio data to the end user via the end user's desired medium.

6. The method of distributing audio data as defined in claim 5, wherein the wireless communications device is a mobile or cell phone.

7. The method of distributing audio data as defined in claim 5, wherein the audio data is a transcript of the live audio.

8. The method of distributing audio data as defined in claim 5, wherein the audio data is an audible file of the live transmission.

9. The method of distributing audio data as defined in claim 7, wherein the analyzing of the audio data for the user's key content preferences includes a keyword search of the transcript of the live audio.

10. A method of distributing audio data to an end user in real-time, including:
registering the end user on a media server, including a user's key content preferences;
capturing and transmitting live audio to the media server using a wireless communications device;
receiving and processing the received captured live audio into audio data on the media server;
analyzing the audio data for the user's key content preferences;
notifying the end user of the audio data, according to the user's key content preferences;
receiving a request for access to the audio data from the end user; and
distributing the audio data to the end user via the end user's desired medium.

11. The method of distributing audio data as defined in claim 10, wherein the wireless communications device is a mobile or cell phone.

12. The method of distributing audio data as defined in claim 10, wherein the audio data is a transcript of the live audio.

13. The method of distributing audio data as defined in claim 10, wherein the audio data is an audible file of the live transmission.

14. The method of distributing audio data as defined in claim 12, wherein the analyzing of the audio data for the user's key content preferences includes a keyword search of the transcript of the live audio.

15. The method of distributing audio data as defined in claim 10, wherein registering the end user on a media server includes receiving billing information from the end user.

16. A method of distributing audio data to an end user in real-time, including:
registering the end user on a media server, including a user's key content preferences;
notifying the end user of an audio broadcast, according to the user's key content preferences, prior to the commencement of the audio broadcast;
receiving a request for access to audio data relating to the audio broadcast from the end user;
capturing the audio broadcast once it commences using a wireless communications device; and
distributing the audio data to the end user.

17. The method of claim 16, wherein the audio data is at least one selected from the group consisting of: a direct streaming of the audio; and a transcription of the audio broadcast.

18. A system for distributing audio data to an end user in real-time, including:
a wireless communications device configured to capture and transmit live audio; and
a media server configured to receive and process the live audio transmission into audio data, the media server including:
an administrative module configured to notify the end user of the audio data;
an access module configured to receive and process a request for access to the audio data from the end user; and
a distribution module configured to distribute the audio data to the end user.

19. The system of claim 18, wherein the wireless communications device is a mobile or cell phone.

20. The system of claim 19, wherein the audio data is a transcription of the live audio.

21. The system of claim 19, wherein the audio data is an audible file of the live transmission.

22. The system of claim 19, wherein the administrative module includes a database comprising registration details of end users, including contact information, desired medium to receive requested audio data, and billing information.

23. (canceled)
